(19) United States
(12) Patent Application Publication
(10) Pub. No.: US 2014/0294039 A1
(43) Pub. Date: Oct. 2, 2014

(54) METHODS AND AN APPARATUS FOR HETEROGENEITY CHARACTERIZATION AND DETERMINATION OF THERMAL CONDUCTIVITY OF MATERIALS

(71) Applicants: Yury Anatolievich Popov, Moscow (RU); Anton Vladimirovich Parshin, Moscow (RU)

(72) Inventors: Yury Anatolievich Popov, Moscow (RU); Anton Vladimirovich Parshin, Moscow (RU)

(73) Assignee: SCHLUMBERGER TECHNOLOGY CORPORATION, SUGAR LAND, TX (US)

(21) Appl. No.: 14/119,685

(22) PCT Filed: May 31, 2011
(86) PCT No.: PCT/RU2011/000379

§ 371 Date: May 9, 2014

(51) Int. Cl. G01N 25/18

(52) U.S. Cl. CPC G01N 25/18
USPC 374/44

(57) ABSTRACT

The methods of heterogeneity characterization and determination of thermal conductivity of materials provides for heating a surface of the heterogeneous solid samples during the movement of the samples relative to a heating source and a temperature recording unit. Prior to the measurements the measurement parameters are adjusted so as to provide the best spatial resolution and a required uncertainty of the measurements. Distributions of initial temperature on the surface of the samples before and after heating are measured and heterogeneity of the samples is estimated on the basis of the temperature change along the line of the temperature recording unit movement. Thermal conductivity of homogeneous regions of the samples is determined using solution of the coefficient inversed problem with the measured temperatures.

### FIELD OF THE INVENTION

The present invention relates to the field for studying thermophysical properties of materials which include heterogeneity characterization and thermal conductivity determination. Heterogeneity characterization resides in obtaining information about magnitude and character of heterogeneity of solid, weakly consolidated or unconsolidated materials which properties change within the volume of sample studied, determining the boundaries and selecting the areas which differ by its thermophysical properties.

Materials under studying can include for example industrial materials, unconsolidated, weakly consolidated and consolidated rock samples, minerals and drill cuttings. Data obtained as the result of applying the present invention can be applied for example in oil-gas industry and mining for selection of homogeneous and heterogeneous zones in reservoirs and formations, prediction of rock heterogeneity in other physical properties, heat and mass transfer modeling, temperature logging data interpretation, determination of heat flow density in formations, study of correlations of thermal conductivity with other physical properties, development and optimization of enhanced oil recovery technologies, indirect estimation or indication of rock fluid-saturation, estimation of kerogene content in rocks, thermal maturation, prediction of rock porosity and fracturing and pore space geometry, estimation of anisotropy of thermal conductivity, thermal diffusivity and other physical properties.

### BACKGROUND OF THE INVENTION

RU patent No 2211446, cl. G01N 25/18, discloses a method for contactless determination of thermal conductivity of materials which includes movement of two temperature detectors and a heating source over the sample under studying without emitting heating energy on it, measurement of temperature on surface of the sample with the first temperature detector and synchronized measurements of environmental temperature. After that obtained results are used to determine coefficient which equals to product of emissivity of material surface and transparency of environment separating the material surface and measurement head. Further, the sample under studying is heated with thermal pulses emitted from the point movable heating source provided that the heating temperature of the sample is measured at the same time. A known relationship is further used to determine thermal conductivity of sample from the results of temperature measurement.

This method does not allow obtaining information about magnitude and character of heterogeneity of sample under studying. Moreover the method is not accurate enough to determine thermal conductivity of samples under studying due to excessive approximation of heat dissipation area from the sample surface.

RU patent No 2153664, cl. G01N25/18, discloses the method for contactless determination of thermal conductivity of materials which includes heating up the sample surface during relative movement of platform with samples and heating unit, recording of initial temperature and temperature of heating of studied materials, determination of limiting excessive temperatures and calculation of thermal conductivity based on recorded excessive temperatures.

The method above resides in the absence of possibility to provide high spatial resolution during estimation of magnitude and character of heterogeneity of materials as well as to provide high accuracy of thermal conductivity determination at the same time. This is related to the following facts. Firstly, conditions under which the best spatial resolution of heterogeneity characterization of materials and possibility to determine thermal conductivity with specified error margin are not determined in the method because the algorithm of operating parameters selection for optimal combination of heterogeneity characterization and thermal conductivity determination is missing. Thirdly, random fluctuations of heating power can not provide the required accuracy of thermal conductivity determination and adequate heterogeneity characterization of materials. Fourthly, fluctuations of position of heated material surface relative to heating source and unit of initial and excessive temperature recording can introduce uncontrolled error to the results of excessive temperature measurement that leads to unacceptable errors in the results of heterogeneity characterization and thermal conductivity determination of materials when optical axes of optical heater and optical temperature detector are not parallel. Given deficiency appears in those cases when heating of materials under studying is conducted by the optical means which is currently nearly the only condition of method implementation. In such a case there is no possibility to provide parallel location of optical axes of heating source (laser or electrical bulb) and optical temperature recording unit at small distances (from several millimeters to several centimeters) between heating spot and temperature recording section of the heated surface behind the heating spot. This leads to changes of distance between the heating spot and section of temperature recording of heated surface behind the heating spot induced by fluctuations of position of heated material surface relative to heating source and unit of initial and excessive temperature recording. In turn, changes of distance between the heating spot and section of temperature recording of heated surface behind the heating spot lead to significant fluctuations of excessive temperature of heating and ultimately to unacceptable distortion of results of heterogeneity characterization and thermal conductivity determination of materials.

The method disclosed in patent RU No 2153664 is employed by an apparatus which consists of the platform for placing the samples under studying and reference samples with known thermal conductivity and heating-recording unit. The heating-recording unit includes temperature detector and heating source of samples in the form of laser, lamp or convective heating source. Given apparatus can also be characterized by the same disadvantages mentioned above for the method that is employed by it for characterization of heterogeneity and thermal conductivity determination of materials.

### SUMMARY OF THE INVENTION

The present invention of heterogeneity characterization and thermal conductivity determination of materials allows characterizing heterogeneity of materials with high spatial resolution as wells as recording detailed distribution of excessive temperature and thermal conductivity simultaneously that corresponds to required accuracy of thermal conductivity determination.

The present invention of heterogeneity characterization and thermal conductivity determination of materials includes the following steps.

During preliminary preparation to the measurements random and systematic errors of thermal conductivity determination are set. A minimum value of time response of a temperature recording unit which is used for measuring temperature of the samples is adjusted so as to provide the resolution of the temperature recording unit not exceeding the value corresponding to given random error of determination of thermal conductivity of materials.

Further, the size of a heating spot produced by a heating source on a surface of a sample, power of the heating source, the size of a temperature recording section located on the surface of each sample behind the heating spot along a line of its movement, a minimum distance between the heating spot and the temperature recording section, and a maximum constant speed of the heating source and the temperature recording unit movement relative to the samples, the temperature recording unit and the heating source being immovable to each other, are adjusted so as to simultaneously provide a high spatial resolution of the heterogeneity characterization of materials, given random and systematic errors of thermal conductivity determination and heating of the samples surface to a level not exceeding the maximum allowable heating temperature of materials.

Then at least one reference sample with known thermal conductivity is selected based on the estimated value of thermal conductivity of an investigated sample and the distribution of initial temperature on the surface of each reference sample is measured.

Further, the constant speed movement of the heating source and the temperature recording unit which are immovable relative to each other is provided relative to the reference samples with simultaneous heating of the reference samples surfaces by the heating spot moving on the surfaces of the reference samples along a straight line with constant speed. After heating the temperature distribution on the surface of each reference sample in the temperature recording section is measured.

Further, the distribution of initial temperature on the surface of each investigated sample is measured.

The constant speed movement of the heating source and the temperature recording unit which are immovable relative to each other is provided relative to the investigated samples with simultaneous heating of the surfaces of the samples by the heating spot moving on the surfaces of the investigated samples along a straight line with constant speed. After heating the temperature distribution on the surface of each investigated sample in the temperature recording section is measured.

Then the excessive heating temperatures of the samples are calculated as the difference between the measured values of surface temperatures after heating and initial surface temperatures.

In accordance with the change of excessive heating temperature of the investigated samples along the line of the heating spot and the temperature recording unit movement taking into account distribution of initial temperature along the line of the temperature recording unit movement, characterization of heterogeneity and boundaries of heterogeneous regions of the investigated samples is carried out and thermal conductivity of homogeneous regions is determined using solution of the coefficient inversed problem with the excessive heating temperatures calculated.

Thermal conductivity of homogeneous regions of the investigated samples can be determined from formula:

$$λ = K / ( {\sum }_{i = 1}^{N} ( {T}_{i} - {T}_{0 i} ) / N ) , i = \overline{1 … {N}_{1}} , \qquad ( 1 )$$

where K is the constant quantity, established based on results of recording initial temperature and temperature after heating on the surface of at least one reference sample with known thermal conductivity,

T₀ᵢ is the initial temperature on i-th surface section of the investigated sample along the line of the heating spot and the temperature recording unit movement,

Tᵢ is the temperature on i-th surface section of the investigated sample along the line of heating spot and the temperature recording unit movement after heating,

(Tᵢ−T₀ᵢ) is the excessive temperature of heating of the investigated sample on i-th surface section of the investigated sample along the line of the heating spot and the temperature recording unit movement,

N is the total number of surface sections of the investigated sample along the line of the heating spot and the temperature recording unit movement where initial surface temperature and surface temperature after heating were measured.

According to another embodiment of the present invention during preliminary preparation to the measurements random and systematic errors of thermal conductivity determination are set. A minimum value of time response of a temperature recording unit which is used for measuring temperature of the samples is adjusted so as to provide the resolution of the temperature recording unit not exceeding the value corresponding to given random error of determination of thermal conductivity of materials.

Further, the size of a heating spot produced by a heating source on a surface of a sample, power of the heating source, the size of a temperature recording section located on the surface of each sample behind the heating spot along a line of its movement, a minimum distance between the heating spot and the temperature recording section and a maximum speed of the heating source and the temperature recording unit movement relative to the samples, the temperature recording unit and the heating source being immovable to each other, are adjusted so as to simultaneously provide a high spatial resolution of the heterogeneity characterization of materials, given random and systematic errors of thermal conductivity determination and heating of the samples surface to a level not exceeding the maximum allowable heating temperature of materials.

Then at least one reference sample with known thermal conductivity is selected based on the estimated value of thermal conductivity of an investigated sample and is set successively with at least one investigated sample along the line of movement of the heating source and the temperature recording unit. The distributions of initial temperature on the surface of each reference sample and on the surface of each investigated sample are measured.

Further, the constant speed movement of the heating source and the temperature recording unit which are immovable relative to each other is provided relative to the reference and investigated samples with simultaneous heating of the reference samples and investigated samples surfaces by the heating spot moving on the surfaces of the samples along a straight line with constant speed.

After heating the temperature distribution on the surface of each sample in the temperature recording section is measured.

Then the excessive heating temperatures of the reference and investigated samples are calculated as the difference between the measured values of surface temperatures after heating and initial surface temperatures.

In accordance with the changes in excessive heating temperature of the investigated samples along the line of the heating spot and the temperature recording unit movement taking into account distribution of initial temperature of the investigated samples along the line of the temperature recording unit movement characterization of heterogeneity and boundaries of heterogeneous regions of the investigated samples is carried out and thermal conductivity of homogeneous regions is determined using solution of the coefficient inversed problem with the excessive heating temperatures calculated.

Thermal conductivity of homogeneous regions of the investigated samples can be determined from formula:

$$λ = {λ}_{ref} ( {\sum }_{k = 1}^{N} ( {T}_{refk} - {T}_{ref 0 k} ) / {N}_{1} ) / ( {\sum }_{i = 1}^{N} ( {T}_{i} - {T}_{0 i} ) / N ) , \\ i = \overline{1 … N} , k = \overline{1 … {N}_{1}} , \qquad ( 2 )$$

where T_{ref0k} is the initial temperature on k-th surface section of the reference sample along the line of the heating spot and the temperature recording unit movement,

T_{refk} is the temperature on k-th surface section of the reference sample along the line of the heating spot and the temperature recording unit movement after heating,

(T_{refk}−T_{ref0k}) is the excessive heating temperature on k-th surface section of the reference sample along the line of the heating spot and the temperature recording unit movement,

Nₗ is the total number of surface sections of the reference sample along the line of the heating spot and the temperature recording unit movement where initial surface temperatures and surface temperatures after heating were measured,

T₀ᵢ is the initial temperature on i-th surface section of the investigated sample along the line of the heating spot and the temperature recording unit movement,

Tᵢ is the temperature on i-th surface section of the investigated sample along the line of the heating spot and the temperature recording unit movement after heating,

(Tᵢ−T₀ᵢ) is the excessive heating temperature on i-th surface section of the sample along the line of the heating spot and the temperature recording unit movement,

N is the total number of surface sections of the investigated sample along the line of the heating spot and the temperature recording unit movement where initial surface temperatures and temperatures after heating were measured.

Characterization of levels of the initial surface temperature of the samples and the surface temperature of the samples after heating, the level of excessive heating temperature and estimation of the relationship of excessive heating temperatures of the reference samples and the investigated samples of materials can be made by recording electrical signals corresponding to the initial surface temperature and the temperature of the reference samples and the investigated samples of materials after heating, and estimating of the ratio of electrical signals corresponding to the excessive surface temperature and the temperature of the reference samples and the investigated samples of materials after heating.

In the case of embodiment when reference and investigated samples are successively located along the line of the heating source and the temperature recording unit movement the power of the heating source for heating the surface of the investigated samples can be set differently from the power of the heating source for heating the surface of the reference samples.

In another embodiment it is possible to use at least two reference samples with known thermal conductivity. In this case the thermal conductivity of a reference sample should be higher and the thermal conductivity of the second reference sample should be lower than the thermal conductivity of the sample material.

In another embodiment prior to the measurements the reference and investigated samples are placed so that the oscillations of the position of the sample surfaces being heated and their parts with respect to the heating source and the temperature recording unit during measurements do not exceed a predetermined acceptable value.

In yet another embodiment of the invention prior to the measurements the dependencies of the surface heating temperature measurement error and associated error of heterogeneity characterization and errors in determining the thermal conductivity of the samples on the value of the oscillations of the position of the sample surfaces being heated and their parts with respect to the heating source and the temperature recording unit are defined. Then, in the process of measurement, the value of an oscillation of the position of the sample surfaces being heated and their parts with respect to the heating source and the temperature recording unit is recorded. And when the measurement of the sample surface temperature after heating is completed, the correction to the results of the temperature measurement is introduced in accordance with the defined dependencies of the surface temperature measurement error, error of heterogeneity characterization and errors in determining the thermal conductivity of the samples on the value of the oscillations of the position of the sample surfaces being heated and their parts with respect to the heating source and the temperature recording unit

In another embodiment of the present invention before the measurements the heating source and the temperature recording unit are installed relative to the sample surface so that during measurements the relative change of the samples temperature due to the oscillations of the position of the sample surfaces being heated relative to the heating source and the temperature recording unit do not exceed the predetermined value.

In another embodiment of the present invention during heating of the samples the power fluctuations of the heating source and locations of the heated spot on the sample surfaces which correspond to these power fluctuations of the heating source are recorded. And after heating corresponding corrections are introduced to the measured temperatures along the samples for those sections of sample surface to which recorded fluctuations of the heating source power correspond.

To implement the method described above an apparatus is proposed which comprises a platform for disposing investigated samples of materials and/or reference samples with known thermal conductivity, a heating source forming a heating spot on the surfaces of the investigated and/or reference samples and a temperature recording unit comprising at least one temperature detector. The heating source and the temperature recording unit are immovable relative to each other but are movable together one after another relative to the platform along the line of the heating spot movement on the sample surface.

The apparatus also includes a time response adjustment unit for the temperature recording unit, a temperature spatial resolution adjustment unit for the temperature recording unit, a unit for adjustment of distance between the heating spot and a temperature recording section located on the surface of each sample behind the heating spot along a line of its movement, a unit for adjustment of velocity of relative movement of the platform and the heating source with the temperature recording unit, a unit for adjustment of the heating spot dimensions, a unit for adjustment of the temperature recording section dimensions, a unit for adjustment of heating source power, and a unit for heating source power recording.

The temperature recording unit can include two separate temperature detectors: one detector for measuring the initial surface temperature of samples and another detector for measuring the surface temperature of samples after heating so that the heating source is located between the detector for measuring the initial surface temperature of samples and detector for measuring the surface temperature of samples after heating.

Also the apparatus can include a unit for adjustment of heated surface of samples relative to the heating source and the temperature recording unit.

In another embodiment the apparatus can include a unit for recording the level of fluctuations of heated surface of samples and its separate sections relative to the heating source and the temperature recording unit during measurements.

The unit for adjustment of heated surface of samples and the unit for recording the level of fluctuations of heated surface of samples and its separate sections can be combined in the single unit.

In another embodiment the apparatus can include a unit for correction of temperature measurement results of heated surface of samples after heating.

In yet another embodiment the apparatus can include a unit for recording the power fluctuations of the heating source, a unit for recording locations of the heating spot during heating of samples which correspond to these power fluctuations and a unit for correction of recorded values of heating temperature of a sample after the heating in accordance with recorded power fluctuations of the heating source which correspond to recorded heating power fluctuations.

### BRIEF DESCRIPTION OF THE DRAWINGS

The aspects of the present invention are accompanied by the drawings.

FIG. 1 shows the schematic positioning of the heated surface of samples of materials and/or reference samples with known thermal conductivity relative to the heating source and the temperature recording unit during heterogeneity characterization and determination of thermal conductivity of materials.

FIG. 2 shows a functional scheme of an apparatus for heterogeneity characterization and determination of material's thermal conductivity.

FIG. 3 shows the results of excessive temperature measurements and determination of thermal conductivity along the line of the heating spot movement obtained with the apparatus described in the present invention and the one described in prior art on the same sample.

### DETAILED DESCRIPTION OF THE INVENTION

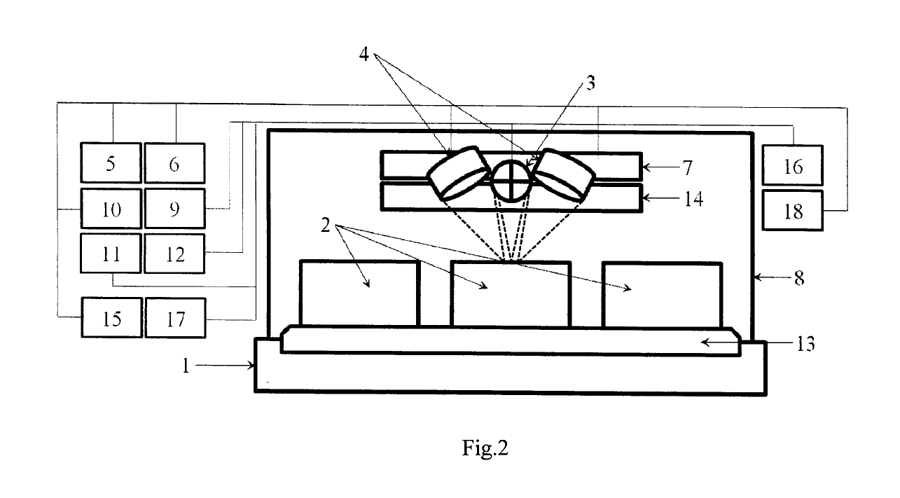

An embodiment of the present invention is described below. FIG. 2 is a block diagram showing an apparatus for heterogeneity characterization and determination of material's thermal conductivity which comprises a platform 1 for placing samples 2 under studying and/or reference samples with known thermal conductivity, a heating source 3, and a temperature recording unit 4 which includes two temperature detectors. The platform 1, the heating source 3 and the temperature recording unit 4 are disposed so that the heating source 3 and the temperature recording unit 4 are immovable relative to each other and can move one after the other along the line of movement of temperature recording section over the sample surface. The platform 1 and the heating source 3 with the temperature recording unit 4 have the possibility of movement relative to each other.

The apparatus according to the present invention also comprises a time response adjustment unit 5 for the temperature recording unit 4, a temperature spatial resolution adjustment unit 6, a unit 7 for adjustment of distance between the heating spot and a temperature recording section located on the surface of each sample behind the heating spot along a line of its movement, a unit 8 for adjustment of velocity of relative movement of the platform 1 with samples 2 under studying and the heating source 3 with the temperature recording unit 4. The apparatus also comprises a unit 9 for adjustment of the heating spot dimensions, a unit 10 for adjustment of the temperature recording section dimensions, a unit 11 for adjustment of the heating source power and a unit 12 for the heating source power recording.

In another embodiment the apparatus can also comprise a unit 13 for adjustment of position of samples 2 which enables alignment of position of samples 2 relative to the heating source 3 and the temperature recording unit 4 with limitation of the level of sample surface position fluctuations within acceptable value. This unit is installed to enable alignment of position of samples 2 relative to the heating source 3 and the temperature recording unit 4 provided that during measurements the fluctuations of position of heated surface of samples 2 relative to the heating source 3 and the temperature recording unit 4 are remained within the value given in advance.

In an alternate embodiment of the invention, the apparatus can include a unit 14 for recording the level of fluctuations of heated surface of samples 2 and its separate sections relative to the heating source 3 and the temperature recording unit 4. The unit 13 for adjustment of position of samples 2 and the unit 14 for recording the level of fluctuations of heated surface of samples 2 and its separate sections can be combined in the same unit.

In yet another alternate embodiment of the present invention, the apparatus comprises a unit 15 for correction of temperature measurement results of heated surface of samples 2. The unit 15 is used to take into account correction factor which is determined according to established relationships between temperature recording error of samples 2 and thermal conductivity determination error of samples 2 depending on the level of samples 2 heated surface position fluctuations relative to the heating source 3 and the temperature recording unit 4.

In yet another alternate embodiment of the present invention, the apparatus includes a unit 16 for recording the power fluctuations of the heating source 3. The unit 16 records the power fluctuations of the heating source 3 during the heating of samples 2 relative to the value given in advance. The apparatus also includes a unit 17 for recording locations of the heating spot during heating of samples 2 which correspond to the power fluctuations. Moreover, the apparatus includes a unit 18 for correction of recorded values of heating temperature after the heating of samples 2 in accordance with recorded power fluctuations of the heating source 3 which correspond to recorded heating power fluctuations.

The method described herein for heterogeneity characterization and thermal conductivity determination of materials provides significantly higher detailed recording of excessive temperature distribution for every sample studied along with thermal conductivity determination with given accuracy. This is achieved by selection of necessary combination of operating parameters which have to provide simultaneous performance of the following requirements: firstly, determinations of thermal conductivity with defined admissible random and systematic errors and, secondly, insuring the highest spatial resolution under conditions of defined random and systematic errors for thermal conductivity determination.

In accordance the current embodiment random and systematic errors of material's thermal conductivity are defined. Further, the lowest time response of the temperature recording unit is set whereby temperature resolution of the temperature recording unit would not exceed in its value the value corresponding to defined random and systematic errors of thermal conductivity determination of materials. Time response which characterizes response time of the temperature recording unit and temperature resolution are interrelated quantities. They are interrelated in such a way that decrease of time response leads to increase by value (degradation) of temperature resolution of the temperature recording unit and vice versa, increase of time response leads to decrease by value (improvement) of temperature resolution of the temperature recording unit. Decrease of time response improves spatial resolution of heterogeneity characterization of materials because it allows much better and clear selection of boundaries of heterogeneous areas and makes it possible to select heterogeneous areas of materials with small length along the surface of materials. While decrease by value (improvement) of temperature resolution of the temperature recording unit decreases random error of thermal conductivity determination of materials. Therefore in order to provide the highest spatial resolution of the temperature recording unit for heterogeneity characterization of materials time response of the temperature recording unit is decreased to the extent possible, but only to its minimum value which insures the value of temperature resolution of the temperature recording unit on the level which corresponds to the defined allowable level of random error of thermal conductivity determination of materials. Prescribing the minimum allowable time response and maximum allowable temperature resolution of the temperature recording unit by its value is one of the key stages in order to provide high spatial resolution of heterogeneity characterization of materials along with maintenance of necessary quality of definition of thermal conductivity.

Further the shortest distance between the heating spot and the section of temperature recording, highest velocity of relative movement of the platform with samples, the heating source and the temperature recording unit as well as the dimensions of the heating spot, dimensions of the temperature recording section and heating power are defined provided that high spatial resolution of material heterogeneity characterization, prescribed random and systematic errors of thermal conductivity determination of materials and heating of the surface of samples to the level not exceeding maximum allowable heating temperature of materials are achieved. During selection of these parameters of measurement mode it is taken into account that decrease of distance between the heating spot and the section of temperature recording and increase of velocity of relative movement of the platform with samples, the heating source and the temperature recording unit lead to improvement of resolution of material heterogeneity characterization. But at excessive reduction of distance between the heating spot and the temperature recording section and excessive increase in velocity of relative movement from one hand of the platform with studied samples, and on the other hand the heating source and the temperature recording unit the systematic error of definition of thermal conductivity of materials can become above demanded its admissible level (patent RU No 2153664, cl. G01N25/18, 1999). Reduction of the dimensions of the heating spot leads to improvement of spatial resolution of heterogeneity characterization of materials and decrease of a systematic error of definition of thermal conductivity of materials, but leads also to increase of heating energy concentration that can cause an overheat of a material to temperature above its admissible level, and reduction of heating source power in that case can lead to increase of a systematic error of definition of thermal conductivity of materials above its defined admissible level (patent RU No 2153664, cl. G01N25/18, 1999). Reduction of the dimensions of the temperature recording section leads to decrease of systematic error of definition of thermal conductivity, but simultaneously lowers temperature resolution of the temperature recording unit that causes increase of a systematic error of definition of thermal conductivity of materials and can lead to increase of a systematic error of definition of thermal conductivity of materials to level above its defined admissible value (patent RU No 2153664, cl. G01N25/18, 1999). Increase of the heating source power facilitates reduction of systematic error of definition of thermal conductivity of materials, but the excessive increase in the heating source power will lead to an overheat of a surface of a material above the maximum admissible temperature.

At least one reference sample with known thermal conductivity is selected based on prospective value of thermal conductivity of investigated samples and then placed along the line of the heating source and the temperature recording unit movement. Distribution of initial temperature of surface of at least one reference sample with known thermal conductivity is determined and heating of a surface of the reference sample by the heating spot produced by the heating source and moving on a surface of the reference sample along a straight line with constant speed are carried out. After the heating stage the distribution of temperature of heated surface of each investigated sample is conducted by recording the temperature of heated surface on the temperature recording section located on the surface of each investigated sample in the area of the heating spot movement behind it and moving along a heated up surface of the investigated sample with the velocity equal to velocity of movement of the heating spot.

Further the measurements with regard to investigated samples of materials are conducted, keeping parameters of measurement mode such as distance between the heating spot and the temperature recording section, velocity of relative movement of the platform with samples, the heating source and the temperature recording unit, dimensions of the heating spot, dimensions of the temperature recording section the heating source power the same as they have been chosen for measurements on the reference sample with known thermal conductivity.

In yet another embodiment of present invention the measurements are conducted when the power of heating of investigated materials surface q is set another than the power of heating of reference materials surface q_{ref}. In this case the ratio of heating powers q/q_{ref} is established and all values of excessive heating temperature recorded during measurement on investigated material sample is multiplied by coefficient q_{ref}/q.

If it is necessary to improve the accuracy of determination of thermal conductivity of materials it is possible to reduce a systematic error of determination of thermal conductivity of materials, having selected and included in preliminary measurements not one reference sample with known thermal conductivity, but and a series—two and more—reference samples with known thermal conductivity, having chosen them so that their thermal conductivity is as much close to thermal conductivity of the investigated samples of a material as possible, but this being the case thermal conductivity of one reference sample should be little higher, and thermal conductivity of other reference sample should be slightly lower, than thermal conductivity of the investigated sample.

Further, in the course of measurements the distribution of initial surface temperature of investigated samples is defined within each sample along the line of movement of the temperature recording unit. After heating the distribution of a surface temperature of investigated samples behind the heating spot or within the heating spot within each sample along the line of movement of heating spot is measured by means of the temperature recording unit. The temperature recording section on heated surface of investigated samples moves behind the heating spot along the surface of samples along the line of the heating spot movement with the velocity equal to the speed of the heating spot movement. Determination of distribution of initial temperature of surface of investigated samples within each sample allows considering fluctuations of initial temperature along the investigated sample during definition of excessive heating temperature of samples. This raises the accuracy of heterogeneity characterization and the accuracy of determination of thermal conductivity of materials.

Excessive heating temperatures are determined from the difference of measured values of temperature of surface of investigated samples after the heating and initial surface temperature.

For determination of thermal conductivity either results of recording the levels of initial temperature of sample surface and temperature of sample surface after the heating, the level of excessive temperature heating and estimation of ratio of excessive heating temperatures of reference samples and investigated materials, or results of recording electrical signals which correspond to initial surface temperature and temperature of reference sample and investigated samples after the heating and estimation of ratio of electrical signals which correspond to excessive temperatures of surface reference samples and investigated samples after the heating.

Characterization of the type and degree of heterogeneity and boundaries of heterogeneous sections of investigated samples is conducted based on the type and degree of excessive temperature variation along the whole line of movement of the heating spot with consideration of initial temperature distribution of investigated sample material along the line of movement of the temperature recording unit.

The thermal conductivity of homogeneous areas of the samples of materials can be determined by the excessive temperature on the homogeneous regions of the samples, taking into account the initial temperature distribution within the entire sample of the material according to formula (1):

$$λ = K / ( {\sum }_{i = 1}^{N} ( {T}_{i} - {T}_{0 i} ) / N ) , i = \overline{1 … N}$$

where K is the constant quantity, established based on the results of recording initial and temperature after heating on the surface of at least one reference sample with known thermal conductivity,

T₀ᵢ is the initial temperature on i-th surface section of the investigated sample along the line of the heating spot and the temperature recording unit movement,

Tᵢ is the temperature on i-th surface section of the investigated sample along the line of the heating spot and the temperature recording unit movement after heating,

(Tᵢ−T₀ᵢ) is the excessive temperature of heating of the investigated sample on i-th surface section of the investigated sample along the line of the heating spot and the temperature recording unit movement,

N is the total number of surface sections of the investigated sample along the line of the heating spot and the temperature recording unit movement where temperatures of the sample are measured.

Quantity of K is determined during preliminary measurements in the following way.

According to [Popov Yu. A., Semenov V. G., Korostelev V. M. and Berezin V. V. “Noncontact evaluation of thermal conductivity of rocks with the aid of a mobile heat source”, Izvestiya Earth Physics, 1983, v. 7, pp. 86-93], the limiting excessive temperature (T_{ref}−T_{0ref}) of heating of a reference sample with known thermal conductivity λ_{ref} at constant initial temperature of surface of reference sample with known thermal conductivity is determined by the following relationship:

T_{ref}−T_{0ref}=q/(2πλ_{ref}x), (3)

where T_{ref} is the limiting temperature of reference sample surface with known thermal conductivity after the heating,

T_{0ref} is the initial temperature of reference sample surface,

q is the power of the heating source in the heating spot, which is passed a reference sample heated

x is the distance between the heating spot and the temperature recording section of reference sample surface with known thermal conductivity.

If initial temperature of reference sample surface with known thermal conductivity is not constant along the line of the heating spot movement then the limiting excessive temperature of reference sample with known thermal conductivity according to present invention is determined during the measurements on the reference sample with known thermal conductivity as

$${\sum }_{i = 1}^{{N}_{ref}} ( {T}_{refk} - {T}_{0 refk} ) / {N}_{ref} ,$$

where T_{0refk} is the initial temperature on k-th section of reference sample along the line of the heating spot movement,

T_{refk} is the temperature on k-th section of reference sample along the line of the heating spot movement after heating,

N_{ref} is the total number of sections along the line of the heating spot movement where initial temperature and temperature of heating of reference sample are recorded.

Then, according to (3), the limiting excessive temperature of heating of reference sample with known thermal conductivity λ_{ref} at non-constant initial temperature of reference material surface with known thermal conductivity is determined by the following relationship:

$${\sum }_{i = 1}^{{N}_{ref}} ( {T}_{refk} - {T}_{0 refk} ) / {N}_{ref} = q / ( 2 {πλ}_{ref} x ) \qquad ( 4 )$$

According to [Popov Yu. A., Semenov V. G., Korostelev V. M. and Berezin V. V. “Noncontact evaluation of thermal conductivity of rocks with the aid of a mobile heat source”, Izvestiya Earth Physics, 1983, v. 7, pp. 86-93], the limiting excessive temperature of heating (T−T₀) of homogeneous section of material sample with thermal conductivity λ at constant initial temperature of sample surface is determined by the following relationship:

T−T₀=q/(2πλx), (5)

where T₀ is the initial temperature of sample material along the heating spot movement,

T is the temperature of sample material along the line of the heating spot movement after heating.

If the initial temperature of sample surface along the line of the heating spot movement is not constant then the limiting excessive temperature of homogeneous section of material is determined during the measurements according to the present invention as

$${\sum }_{i = 1}^{N} ( {T}_{i} - {T}_{0 i} ) / N .$$

Then, according to (5), the limiting excessive temperature of homogeneous section of material with thermal conductivity λ at non-constant initial temperature of sample material surface is determined as

$${\sum }_{i = 1}^{N} ( {T}_{i} - {T}_{0 i} ) / N = q / ( 2 πλ x ) . \qquad ( 6 )$$

At constant power of the heating source in the heating spot, the distance between the heating spot and the temperature recording section of reference sample surface with known thermal conductivity and investigated sample and initial temperature of homogeneous section of sample material the thermal conductivity of homogeneous section of investigated sample can be determined from equation that can be obtained from relationship (5):

2=q/(2πx(T−T₀)) (7)

At constant power of the heating source in the heating spot, the distance between the heating spot and the temperature recording section of reference sample surface with known thermal conductivity and investigated sample and non-constant initial temperature of homogeneous section of sample material the thermal conductivity of homogeneous section of investigated samples can be determined from equation that can be obtained from relationship (6):

$$λ = q / ( 2 π x ( {\sum }_{i = 1}^{N} ( {T}_{i} - {T}_{0 i} ) / N ) ) \qquad ( 8 )$$

Combination q/2πx=K is determined from the results of preliminary measurements conducted on at least one reference sample with known thermal conductivity from relationships (3) or (4) and further used in both cases of thermal conductivity determination for homogeneous sections of investigated sample: at constant initial temperature of investigated sample 1 according to (7) and at non-constant temperature of homogenous sections of investigated sample according to (8).

At constant initial temperature of reference sample with known thermal conductivity the quantity of K is determined by equation which follows from (3):

K=q/2λx=(T_{ref}−T_{0ref})·λ_{ref} (9)

At non-constant initial temperature of reference sample with known thermal conductivity the quantity of K is determined by equation which follows from (4):

$$K = q / 2 π x = {λ}_{ref} {\sum }_{i = 1}^{{N}_{ref}} ( {T}_{refk} - {T}_{0 refk} ) / {N}_{ref} \qquad ( 10 )$$

Relationships (7) and (9) give the equation that determines thermal conductivity of homogeneous section of investigated material in case of constant initial temperature of homogeneous section of investigated material:

λ=K/(T−T₀) (11)

Relationships (8) and (10) give the equation (1) that determines thermal conductivity of homogeneous section of investigated sample in case of non-constant initial temperature of homogeneous section of investigated sample

$$λ = K / ( {\sum }_{i = 1}^{N} ( {T}_{i} - {T}_{0 i} ) / N )$$

If during the measurements on the samples the heating power q for the investigated samples is chosen other than the heating power q_{ref} chosen for the measurements on reference samples with known thermal conductivity, then in case of constant initial temperature of surface of homogeneous section of the investigated sample the thermal conductivity of material is determined by equation:

λ=qK/(q_{ref}(T−T₀)), (12)

and in case non-constant initial temperature of surface of homogeneous section of the investigated sample the thermal conductivity of material is determined by equation:

$$λ = qK / ( {q}_{ref} {\sum }_{i = 1}^{N} ( {T}_{i} - {T}_{0 i} ) / N ) . \qquad ( 13 )$$

In another embodiment of the present invention the preliminary measurements using at least one reference sample with known thermal conductivity are carried out only once, and then heterogeneity characterization and determination of thermal conductivity of materials is performed without preliminary measurements on the reference samples. In this case the value of heating power used for the measurements on every reference sample is fixed. During heterogeneity characterization and determination of thermal conductivity of materials the heating power is set as applied in the preliminary measurements for one of the reference samples, for example, which is closest to the thermal conductivity of the investigated sample. In this case, in determining the thermal conductivity of the investigated sample based on formula (1) at constant initial temperature of the homogeneous section of the investigated sample or determining the thermal conductivity of the investigated sample based on formula (11) with non-constant initial temperature of the homogeneous section of the sample the value of the parameter K is used that was defined during the measurements exactly on this reference sample with known thermal conductivity.

If during the measurements on the samples the heating power q of investigated samples is chosen other than the heating power q_{ref} chosen for the measurements on reference samples with known thermal conductivity, then as in the case of measurements with a constant initial temperature of the investigated samples, and in the case of measurements with non-constant initial temperature of the investigated samples all the results of recording of the temperature of the heated surface of the samples or an electrical signal corresponding to the temperature of the heated surface of the samples, is multiplied by the factor q_{ref}/q.

In yet another embodiment of the invention one or more reference samples and investigated samples are placed on the platform at the same time. In this case, just as during the preliminary preparation for the measurements random and systematic errors in determining the thermal conductivity of materials are defined and the minimum possible value of time response of the temperature recording unit is selected so that temperature resolution of the temperature recording unit in its magnitude does not exceed the value corresponding to a given random errors in determining the thermal conductivity of materials. The minimum possible distance between the heating spot and the temperature recording section, the maximum possible velocity of relative movement of the samples, the heating source and the temperature recording unit as well as the size of the heating spot, the size of the temperature recording section and power of the heating source are set to simultaneously provide high spatial resolution of heterogeneity characterization of materials, given the random and systematic errors in determining the thermal conductivity of materials and heating of the surface material samples to a level not exceeding the maximum permissible temperature of heating of materials.

At least one reference sample with known thermal conductivity is selected based on the estimated value of thermal conductivity of the sample and placed at in series with at least one investigated sample along the line of movement of the heating source and the temperature recording unit. The distribution of initial temperature on the surface of at least one reference sample and on the surface of each investigated sample is determined and the surface of at least one reference sample and the investigated sample is heated by the heating spot formed by the heating source and moving along the surface of the at least one reference sample and each investigated sample along the straight line at constant speed. After heating the distribution of surface temperature of at least one reference sample and each investigated sample is determined in the temperature recording sections located on the surface of at least one reference sample and the investigated samples along the line of movement of the heating spot behind it. The excessive heating temperatures of investigated and reference samples are calculated. On changes of the excessive temperature of the investigated samples along the line of movement of the heating spot and the temperature recording unit taking into account distribution of the initial temperature of the investigated samples along the line of the movement of the temperature recording unit is carried out characterization of the type and degree of heterogeneity of heterogeneous sections of the investigated samples and the determination of the boundaries of inhomogeneous regions of the samples. Thermal conductivity of homogeneous regions can be determined by the formula:

$$λ = {λ}_{ref} ( {\sum }_{k = 1}^{{N}_{1}} ( {T}_{refk} - {T}_{ref 0 k} ) / {N}_{1} ) / ( {\sum }_{i = 1}^{N} ( {T}_{i} - {T}_{0 i} ) / N ) , \\ k = \overline{1 … {N}_{1}} , i = \overline{1 … N} , \qquad ( 14 )$$

where T_{ref0k} is the initial temperature on k-th surface section of the reference sample along the line of movement of the heating spot and the temperature recording unit,
T_{refk} is the temperature on k-th surface section of the reference sample along the line of the heating spot and the temperature recording unit movement after heating,
(T_{refk}−T_{refOk}) is the excessive heating temperature on k-th surface section of the reference sample,
Nₗ is the total number of surface sections of the reference sample along the line of the heating spot and the temperature recording unit movement after heating where initial surface temperatures and surface temperatures after heating are measured,
T₀ᵢ is the initial temperature on i-th surface section of the investigated sample along the line of the heating spot and the temperature recording unit movement,
Tᵢ is the temperature on i-th surface section of the investigated sample along the line of the heating spot and the temperature recording unit movement after heating,
(Tᵢ−T₀ᵢ) is the excessive heating temperature of homogeneous section of investigated sample of material,
N is the total number of surface sections of the investigated sample along the line of the heating spot and the temperature recording unit movement after heating where initial surface temperatures and temperatures after heating of investigated sample are measured.

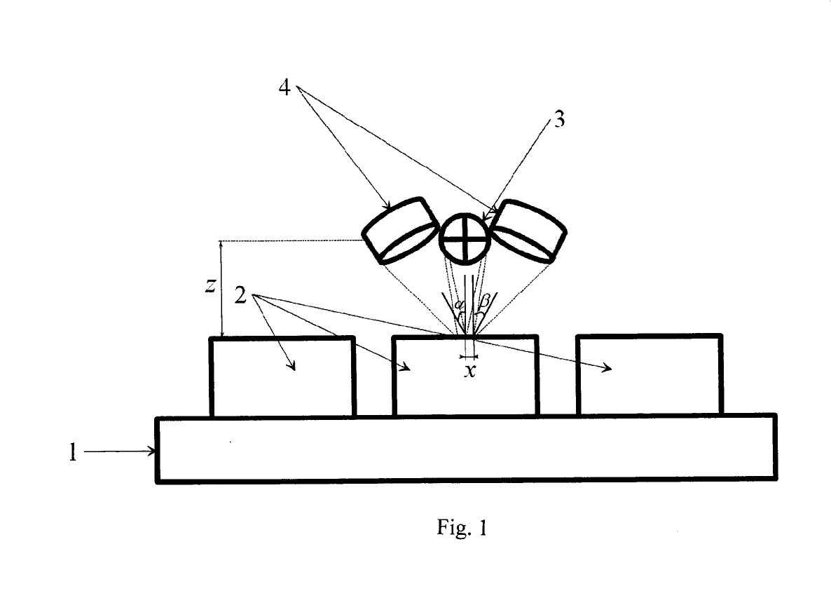

For both proposed options before the measurement the reference samples and samples under study can be installed based on the given allowable error of recording the heating temperature of the samples and a given allowable error in the determination of thermal conductivity of the investigated samples. To do this, the allowable fluctuations Δz of position of surface of the heated samples and the individual sections of the heated sample surface are set relative to the heating source and the temperature recording unit in the course of measurements. Connection of parameter Δz to other different parameters of measurement mode can be set, for example, according to the following relationship (FIG. 1):

Δz=x·δT·cos α·cos β/sin(α+β), (15)

where x is the distance between the center of the heating spot and the center of the temperature recording section established and fixed during preliminary measurements,

$$δ T = \frac{Δ ( T - {T}_{0} )}{T - {T}_{0}}$$

is the given allowable relative change of excessive temperature (T−T₀) of samples due to fluctuations of the heated surface of samples and its separate sections relative to the heating source and the temperature recording unit during measurements, Δ(T−T₀) is the absolute change of the excessive temperature (T−T₀) of investigated samples due to fluctuations of the heated surface of investigated samples and its separate sections relative to the heating source and the temperature recording unit during measurements, α is the angle of incidence of the energy from the heating source on the exposed surface of the samples, β is the angle between the radiation flux of the heated surface of the samples falling in the temperature recording unit, and the normal to the heated samples.

The proposed method may also include definition of measurement error depending on the recording of heating temperature of samples and associated error of heterogeneity characterization and errors in determining the thermal conductivity of the samples of materials on the magnitude of the oscillations of the position of surface of heated samples and the individual sections of the heated surface with respect to the heating source and the temperature recording unit during the preliminary measurements. Dependence of the error of recording the heating temperature of the samples, determining associated error of heterogeneity characterization, on the magnitude of the position oscillations of heated surface of the samples and separate sections of heated surface with respect to the heating source and the temperature recording unit can be determined for example by the ratio:

δT=Δz·sin(α+β)/x·cos α·cos β, (16)

which follows from (15).

As follows from the formula (16), random fluctuations of the position of heated surface of the reference samples and of its individual parts with respect to the heating source and the temperature recording unit during measurements leads to random changes of the excessive heating temperature of the reference samples. According to the formulas (9) and (10), relative fluctuations of the excessive temperature of the reference samples lead to the same relative errors of determination of parameter K value by magnitude. These errors according to the formulas (1) and (11)-(13) lead to the same by magnitude errors in determination of thermal conductivity of investigated samples of materials. That is why control of the magnitude of oscillations of position of the heated surface of samples and its separate sections relative to the heating source and the temperature recording unit during measurements allows correcting the results of determination of parameter K or results of determination of thermal conductivity of investigated samples of materials excluding this error from the results of determination of parameter K or from the results of determination of thermal conductivity of the investigated samples of materials.

As follows from the formula (16), random fluctuations of the position of heated surface of samples of materials and its separate sections relative to the heating source and the temperature recording unit during measurements lead to random changes of the excessive heating temperature of investigated samples of materials. According to the formulas (1), (2), (7), (8), (11)-(14), relative fluctuations of the excessive temperature of samples of materials lead to the same by magnitude changes relative errors of determination of thermal conductivity of materials. That is why control of the magnitude of oscillations of position of the heated surface of samples and its separate sections relative to the heating source and the temperature recording unit during measurements allows correcting the results of determination of thermal conductivity of investigated samples of materials excluding this error from the results of determination of thermal conductivity of samples of materials.

In order to eliminate the error of heterogeneity characterization and determination of the thermal conductivity of materials, that arises during fluctuations of position of the heated surface of the samples and separate sections of heated surface with respect to the heating source and the temperature recording unit, in the process of measurement the value of fluctuation of position of the heated surface and the individual sections of the heated surface with respect to the heating source and the temperature recording unit is recorded. After the recording of heating temperature of the sample surface a correction is introduced to the results of the temperature recording in accordance with dependencies of error of recording the heating temperature of the samples and error in determining the thermal conductivity of the samples on the magnitude of the fluctuations of position of the heated sample surface relative to the heating source and the temperature recording unit.

The proposed method can be supplemented by the fact that in preparation for the measurements the heating source and the temperature recording unit is installed relative to the sample surface so that during the measurements the relative change δT of excessive temperature of the samples due to fluctuations of position of heated sample surface relative to the heating source and the temperature recording unit during the measurement would not exceed, for example, a predetermined value (δT)₀. To fulfill this requirement it is necessary to choose parameters Δz, x and angles α [symbol] β so that the following condition is realized:

Δz·sin(α+β)/x·(cos α·cos β)≦(δT)₀ (17)

In another embodiment during heating of samples power fluctuations of the heating source and locations of the heated spot on the surface of reference and investigated samples which correspond to power fluctuations of the heating source are recorded. From (4) it follows that power fluctuations of the heat source lead to errors in determining the excessive temperature, which lead to the error of heterogeneity characterization and determination of thermal conductivity of samples of materials. To eliminate or reduce these errors corresponding corrections are introduced to the results of recorded values of temperature and thermal conductivity along the samples after heating. These corrections correspond to recorded fluctuations of the heating source power for those sections of sample surface which recorded fluctuations of the heating source power correspond.

Implementation of one of the embodiments of the proposed method of heterogeneity characterization and determination of thermal conductivity of materials by the proposed apparatus can be illustrated by the following example.

Investigated samples 2 of materials, for example, two samples of full core of sandstone are placed on the platform 1. The unit 13 is intended to equalize the position of the surface of the samples 2 with respect to the heating source 3 and the e temperature recording unit 4 with limitations of fluctuations of the surfaces positions of the samples 2 within the allowable value determined, for example, according to the formula (14). The unit 13, for example, can be made as a single-axis positioning table. The single-axis positioning table is equipped with an automatic drive with a micrometer, which assures the alignment of the samples 2 surfaces relative to the heating source 3 and the temperature recording unit 4 providing the fluctuations Δz of position of the heated samples surfaces relative to the heating source 3 and the temperature recording unit 4 during the measurements not exceeding ±5 microns.

The heating source 3 is a contactless heating source, for example diode laser with wavelength 970 nano-meters. The temperature recording unit 4 has two contactless temperature detectors, radiometers, operating in the infra-red spectral range. One of radiometers is the detector for measurements of initial surface temperature of the samples and the other one for the measurements of surface temperature of samples after heating. The heating source 3 is located between the radiometers.

The platform 1 with the samples 2 and the heating source 3 with the temperature recording unit 4 are installed with possibility of relative movement. The heating source 3 and the temperature recording unit 4 are immoveable relative to each other but can move one after the other along the line of movement of the temperature recording section over the samples surface.

During preliminary preparation of the apparatus for the measurements the random error of materials thermal conductivity determination, for example 1.5%, and systematic error of materials thermal conductivity determination, for example 5%, are given to provide the best spatial resolution. The requirement to prevent overheating of the sample material to excessive temperatures above 30° C., which corresponds to the area of the heating spot, is taken into account. Optimization of the parameters of measurements is conducted based on the data requirements made. When optimizing the parameters it is taken into account that improvement of spatial resolution of the heterogeneity characterization of materials is contributed by: reduction in time response of the temperature recording unit; improvement (decrease in value) of the temperature resolution of the temperature recording unit; increasing the velocity of movement of the heating spot and the temperature recording section; reducing the size of the heating spot and the size of the temperature recording section. When choosing the power of the heating source it is taken into account that increase of power reduces random error of thermal conductivity determination of materials, improves possibilities to locate small by sizes and contrast of thermal conductivities zones of heterogeneity of materials. When choosing the power of the heating source it is also taken into account that excessive heating temperature of materials is related to the velocity of movement of the heating spot and the temperature recording section, the distance between the heating spot and the temperature recording section, dimensions of the heating spot, expected thermal conductivity and thermal diffusivity of investigated samples. As a result, in this example by the theoretical estimates and experimental verification were selected time response of the temperature recording unit 4 as 0.2 s, the temperature resolution of the temperature recording unit 4 as 0.1° C., the velocity of movement of the heating spot and the temperature recording section as 3 mm/s, the distance between the center of the heating spot and the center of the temperature recording section as 2 mm, the diameter of the heating spot as 0.6 mm, dimensions of the temperature recording section as 1×1 mm and the power of the heating source as 0.2 W.

During the measurements initial temperature distribution within the reference sample with known thermal conductivity and each investigated sample along the line of movement of the temperature recording unit 4 is determined. Surfaces of reference sample and investigated samples of materials are heated by the heating spot produced by the heating source 3. After heating surface temperature distribution of samples 2, which includes and those areas where the heating temperature is not reached its limit, is measured while taking into account the distribution of the initial temperature of the sample surface along the line of movement of the temperature recording section. Simultaneously during the measurements the unit 14 records the magnitude of fluctuations of heated reference sample and investigated sample 2 surfaces and separate areas of heated sample 2 surface relative to the heating source 3 and the temperature recording unit 4. Moreover, during the measurement the unit 16 records fluctuations of power of the heating source 3 during heating of samples 2. The unit 17 records locations of the heating spot during heating of investigated samples 2 of materials which correspond to these power fluctuations.

After recording of heating temperature of the surface of the reference and investigated samples 2, the correction of results of recording of the surface temperature of the samples 2 is conducted using the unit 15 taking into account correction determined in accordance with established relationships of the error of temperature recording of samples 2 and error in determining the thermal conductivity of the samples 2 on the magnitude of the oscillations of position of the heated sample surface relative to the heating source 3 and the temperature recording unit 4. Moreover, using the unit 18 correction of recorded values of heating temperature after heating of reference and investigated samples 2 is conducted in accordance with recorded fluctuations of the power of the heating source for those areas of surface of samples 2 which correspond to recorded heating power fluctuations.

According to the results of heating the reference sample surface and recording the temperature of the heated reference sample surface value of a constant value K is set. Further, based on the difference of measured surface temperature after heating and measured earlier initial temperature the excessive heating temperature of the samples is determined. After that thermal conductivity of homogeneous sections of investigated samples 2 is determined from limiting excessive temperatures on homogeneous sections of investigated samples 2 taking into account results of recording the distribution of the initial temperature and the heating temperature within each sample by the formula (1).

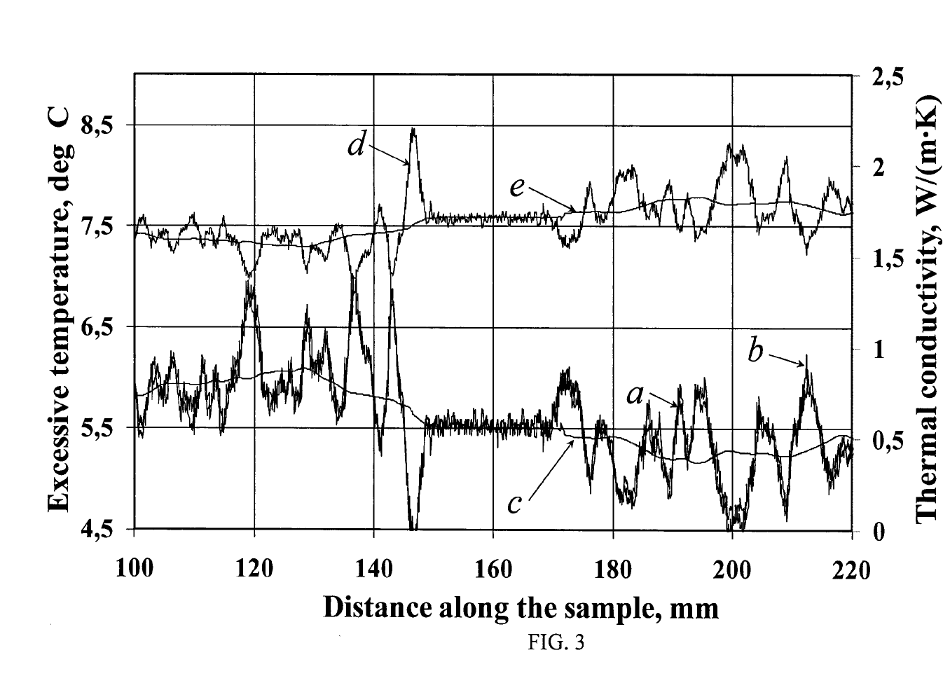

The results of performance verification of the claimed technical solution in comparison with the apparatus described in the patent RU 2153664, are shown in FIG. 3 for two samples of heterogeneous materials—rocks, which were chosen as samples of sandstone. Solid (a) and dotted (b) lines shown on FIG. 3 represent two successive measurements of excessive temperature along the line of movement of the heating spot obtained on the same samples by using the method and the apparatus of the present invention while dashed line (c) is referred to the known method. High reproducibility of measurement results of the proposed apparatus is confirmed by good correspondence between the two profiles (a) and (b) of the excessive temperature along the line of movement of the heating spot and section of temperature recording, obtained by two successive independent measurements. Established in this case root-mean-square (RMS) value of temperature noise does not exceed 0.1 K. It can be seen also from FIG. 3 that there are stable and repeated variations of the excessive temperature along the sample material in sections of 0.5 mm and more in length in sample of the material, while the variations of the excessive temperature are higher than the established value of the RMS temperature noise value during temperature recording by more than 15 times, which indicates that these variations in the excessive temperature indeed characterize heterogeneity of samples of materials. The dashed line (c) in the FIG. 3 reflects the results of heterogeneity characterization of the same sample of sandstone measured by using the known method, i.e. with the parameters of measurement mode, selected without regard to the requirements set forth in the description of the proposed method of heterogeneity characterization of samples and determination of thermal conductivity. Comparison of the distribution of excessive temperature, obtained by using the known and the proposed methods and shown in the FIG. 3 shows that the proposed method provides much more detailed and accurate characterization of heterogeneity of samples of materials. Light dash-dotted line (d) in FIG. 3 shows distribution of the thermal conductivity values along the rock sample from the measurements performed with the suggested technical solution. Heavy dash-dotted line (e) demonstrates distribution of the thermal conductivity values along the same rock sample from the measurements performed with the same method. Thermal conductivity values were calculated from the excessive temperature data.

It should be noted that in homogeneous areas of thermal conductivity values, computed from measurements of the proposed apparatus and the apparatus describes in the patent RU 2153664, are identical within both uncertainties of the methods, indicating that the proposed method provides almost the same quality of definition of thermal conductivity like the known method. Analysis of errors in the determination of thermal conductivity for selected parameters of characterization heterogeneity of samples and determination of thermal conductivity of materials was carried out on a set of 5 reference samples with known thermal conductivity in the range of thermal conductivity of sedimentary rocks from 1 to 7 W/(m·K) Analysis of errors in all range of thermal conductivity from 1 to 7 W/(m·K) showed that random error thermal conductivity determination did not exceed 1.5% and systematic error thermal conductivity determination did not exceed 5% which corresponds to the previously formulated requirements. Thus, given random error in determining the thermal conductivity of materials by 1.5% and a systematic error in the determination of thermal conductivity of materials at 5%, managed to provide the characterization of heterogeneity of selected samples with high spatial resolution—better than 0.5 mm. This means the possibility to identify at the noise level areas of samples of heterogeneous materials with a linear dimension of 0.5 mm or more, characterized by its thermal conductivity from the adjacent areas of samples of heterogeneous materials, which the known method could not provide.

Thus, the data in the FIG. 3 show that the proposed method of the present invention provides a solution to the technical problem—namely, increased functionality, increased accuracy and extend the scope of application of the method of heterogeneity characterization and determination of thermal conductivity of materials.

1. A method of heterogeneity characterization and determination of thermal conductivity of materials comprising the following steps:
setting random and systematic errors of thermal conductivity determination,
adjusting a minimum value of time response of a temperature recording unit which is used for measuring temperature of the samples so as to provide a resolution of the temperature recording unit not exceeding the value corresponding to given random error of thermal conductivity determination,
adjusting a size of a heating spot produced by a heating source on a surface of a sample, power of the heating source, a size of a temperature recording section located on the surface of each sample behind the heating spot along a line of its movement, a minimum distance between the heating spot and the temperature recording section, the heating source and the temperature recording unit being immovable relative to each other, and a maximum constant speed of the heating source and the temperature recording unit movement relative to the samples so as to simultaneously provide a high spatial resolution of heterogeneity characterization of materials, given random and systematic errors of thermal conductivity determination and heating of the samples surface to a level not exceeding the maximum allowable heating temperature of materials,
selecting at least one reference sample with known thermal conductivity based on the estimated value of thermal conductivity of an investigated sample,
measuring the distribution of initial temperature on the surface of each reference sample,
providing the constant speed movement of the heating source and the temperature recording unit relative to the reference samples with simultaneous heating of the reference samples surfaces by the heating spot moving on the surfaces of the reference samples along a straight line with the constant speed,
measuring the temperature distribution on the surface of each reference sample in the temperature recording section after heating,
measuring the distribution of initial temperature on the surface of each investigated sample,
providing the constant speed movement of the heating source and the temperature recording unit relative to the investigated samples with simultaneous heating of the surfaces of the samples by the heating spot moving on the surfaces of the investigated samples along a straight line with the constant speed,
measuring the temperature distribution on the surface of each investigated sample in the temperature recording section after heating,
calculating the excessive heating temperatures of the samples as the difference between the measured values of surface temperatures after heating and initial surface temperatures,
characterizing heterogeneity and boundaries of heterogeneous regions of the investigated samples in accordance with the change of excessive heating temperatures of the investigated samples along the line of the heating spot and the temperature recording unit movement and taking into account distribution of initial surface temperature along the line of the temperature recording unit movement, and
determining thermal conductivity of homogeneous regions of the investigated samples using solution of the coefficient inversed problem with the calculated excessive heating temperatures.

2. The method of claim 1, wherein thermal conductivity of homogeneous regions of the investigated samples is determined from formula:
$$λ = K / ( {\sum }_{i = 1}^{N} ( {T}_{i} - {T}_{0 i} ) / N ) , i = \overline{1 … {N}_{l}} ,$$
where K is the constant quantity, established based on results of recording initial temperature and temperature after heating on the surface of at least one reference sample with known thermal conductivity,
T₀ᵢ is the initial temperature on i-th surface section of the investigated sample along the line of the heating spot and the temperature recording unit movement,
Tᵢ is the temperature on i-th surface section of the investigated sample along the line of heating spot and the temperature recording unit movement after heating,
(Tᵢ−T₀ᵢ) is the excessive temperature of heating of the investigated sample on i-th surface section of the investigated sample along the line of the heating spot and the temperature recording unit movement,
N is the total number of surface sections of the investigated sample along the line of the heating spot and the temperature recording unit movement where initial surface temperature and surface temperature after heating were measured.

3. The method of claim 1, wherein the power of the heating source for heating the surface of the investigated samples is set differently from the power for the heating source for heating the surface of the reference samples.

4. The method of claim 1, wherein at least two reference samples with known thermal conductivity are used, while the thermal conductivity of a reference sample is higher and the thermal conductivity of the second reference sample is lower than the thermal conductivity of the investigated sample.

5. The method of claim 1, wherein prior to the measurements reference and investigated samples are placed so that the oscillations of the sample surfaces being heated and its parts with respect to the heating source and the temperature recording unit during measurements do not exceed a predetermined acceptable value.

6. The method of claim 1, wherein prior to the measurements the dependencies of surface heating temperature measurement error and associated error of heterogeneity characterization and errors in determining the thermal conductivity of the samples of materials on the value of the oscillations of the position of the sample surfaces being heated and their parts with respect to the heating source and the temperature recording unit are defined, recording the value of an oscillation of the position of the sample surfaces being heated and their parts with respect to the heating source and the temperature recording unit in the process of measurement and introducing the correction to the results of the temperature measurement in accordance with the defined dependencies of the heating temperature measurement error, error of heterogeneity characterization and errors in determining the thermal conductivity of the samples on the value of the oscillations of the position of the sample surfaces being heated and their parts with respect to the heating source and the temperature recording.

7. The method of claim 1, wherein before the measurements the heating source and the temperature recording unit are installed relative to the sample surface so that during the measurements the relative change of the samples temperature due to oscillations of the position of the sample surfaces being heated relative to the heating source and the temperature recording unit do not exceed the predetermined value.

8. The method of claim 1, wherein during heating of the samples the power fluctuations of the heating source and locations of the heated spot on the sample surfaces which correspond to these power fluctuations are measured and corresponding corrections tare introduced to the measured temperature along the samples for those sections of sample surfaces to which recorded fluctuations of the heating source power correspond.

9. A method of heterogeneity characterization and determination of thermal conductivity of materials comprising the following steps:
setting random and systematic errors of thermal conductivity determination,
adjusting a minimum value of time response of a temperature recording unit which is used for measuring temperature of the samples so as to provide a resolution of the temperature recording unit not exceeding the value corresponding to given random error of thermal conductivity determination,
adjusting a size of a heating spot produced by a heating source on a surface of a sample, power of the heating source, a size of a temperature recording section located on the surface of each sample behind the heating spot along a line of its movement, a minimum distance between the heating spot and the temperature recording section, the heating source and the temperature recording unit being immovable relative to each other, and a maximum constant speed of the heating source and the temperature recording unit movement relative to the samples so as to simultaneously provide a high spatial resolution of the heterogeneity characterization of materials, given random and systematic errors of thermal conductivity determination and heating of the samples surface to a level not exceeding the maximum allowable heating temperature of materials,
selecting at least one reference sample with known thermal conductivity based on the estimated value of thermal conductivity of an investigated sample,
setting at least one reference sample with known thermal conductivity successively with at least one investigated sample along the line of movement of the heating source and the temperature recording unit,
the distributions of initial temperature on the surface of each reference sample and on the surface of each investigated sample are measured,
the constant speed movement of the heating source with the temperature recording unit which are immovable relative to each other is provided relative to the reference and investigated samples with simultaneous heating of the reference samples and investigated samples surfaces by the heating spot moving on the surfaces of the samples along a straight line with constant speed,
after heating the temperature distribution on the surface of each sample in the temperature recording section is measured,
the excessive heating temperatures of the reference and investigated samples are calculated as the difference between the measured values of surface temperatures after heating and initial surface temperatures,
in accordance with the changes in excessive heating temperature of the investigated samples along the line of the heating spot and the temperature recording unit movement taking into account distribution of initial surface temperature of the investigated samples along the line of the temperature recording unit movement, characterization of heterogeneity and boundaries of heterogeneous regions of the investigated samples is carried out, and
thermal conductivity of homogeneous regions of the investigated samples is determined using solution of the coefficient inversed problem with the calculated excessive heating temperatures.

10. The method of claim 9, wherein thermal conductivity of homogeneous regions of the investigated samples is determined from formula:
$$λ = {λ}_{ref} ( {\sum }_{k = 1}^{{N}_{1}} ( {T}_{refk} - {T}_{ref 0 k} ) / {N}_{1} ) / ( {\sum }_{i = 1}^{N} ( {T}_{i} - {T}_{0 i} ) / N ) , \\ i = \overline{1 … N} , k = \overline{1 … {N}_{1}} ,$$
where T_{refOk} is the initial temperature on k-th surface section of the reference sample along the line of the heating spot and the temperature recording unit movement,
T_{refk} is the temperature on k-th surface section of the reference sample along the line of the heating spot and the temperature recording unit movement after heating,
(T_{refk}−T_{ref0k}) is the excessive heating temperature on k-th surface section of the reference sample along the line of the heating spot and the temperature recording unit movement,
Nₗ is the total number of surface sections of the reference sample along the line of the heating spot and the temperature recording unit movement where initial surface temperatures and surface temperatures after heating were measured,
T₀ᵢ is the initial temperature on i-th surface section of the investigated sample along the line of the heating spot and the temperature recording unit movement,
Tᵢ is the temperature on i-th surface section of the investigated sample along the line of the heating spot and the temperature recording unit movement after heating,
(Tᵢ−T₀ᵢ) is the excessive heating temperature on i-th surface section of the sample along the line of the heating spot and the temperature recording unit movement,
N is the total number of surface sections of the investigated sample along the line of the heating spot and the temperature recording unit movement where initial surface temperatures and temperatures after heating are measured.

11. The method of claim 9, wherein the power of the heating source for heating the surface of the investigated samples is set differently from the power for the heating source for heating the surface of the reference samples.

12. The method of claim 9, wherein prior to the measurements reference and investigated samples are placed so that the oscillations of the sample surfaces being heated and its parts with respect to the heating source and the temperature recording unit during measurements do not exceed a predetermined acceptable value.

13. The method of claim 9, wherein prior to the measurements the dependencies of surface heating temperature measurement error and associated error of heterogeneity characterization and errors in determining the thermal conductivity of the samples of materials on the value of the oscillations of the position of the sample surfaces being heated and their parts with respect to the heating source and the temperature recording unit are defined, recording the value of an oscillation of the position of the sample surfaces being heated and their parts with respect to the heating source and the temperature recording unit in the process of measurement and introducing the correction to the results of the temperature measurement in accordance with the defined dependencies of the heating temperature measurement error, error of heterogeneity characterization and errors in determining the thermal conductivity of the samples on the value of the oscillations of the position of the sample surfaces being heated and their parts with respect to the heating source and the temperature recording.

14. The method of claim 9, wherein before the measurements the heating source and the temperature recording unit are installed relative to the sample surface so that during the measurements the relative change of the samples temperature due to oscillations of the position of the sample surfaces being heated relative to the heating source and the temperature recording unit do not exceed the predetermined value.

15. The method of claim 9, wherein during heating of the samples the power fluctuations of the heating source and locations of the heated spot on the sample surfaces which correspond to these power fluctuations are measured and corresponding corrections tare introduced to the measured temperature along the samples for those sections of sample surfaces to which recorded fluctuations of the heating source power correspond.

16. An apparatus of heterogeneity characterization and determination of thermal conductivity of materials comprising:
a platform for placing investigated samples of materials and/or reference samples,
a heating source forming a heating spot on a surface of reference and investigated samples,
a temperature recording unit comprising at least one temperature detector, the heating source and the temperature recording unit being immovable relative to each other but movable together one after another relative to the platform along the line of the heating spot movement on the sample surface,
a time response adjustment unit for the temperature recording unit,
a temperature spatial resolution adjustment unit for the temperature recording unit,
a unit for adjustment of distance between the heating spot and a temperature recording section located on the surface of each sample behind the heating spot along a line of its movement,
a unit for adjustment of velocity of relative movement of the platform for placing samples and the heating source with the temperature recording unit,
a unit for adjustment of the heating spot dimensions,
a unit for adjustment of the temperature recording section dimensions,
a unit for adjustment of the heating source power, and
a unit for the heating source power recording.

17. The apparatus of claim 16 wherein the temperature recording unit contains one detector for measuring the initial surface temperature of samples and another detector for measuring the surface temperature of samples after heating so that the heating source is located between the detector for measuring the initial surface temperature of samples and the detector for measuring the surface temperature of sample after heating.

18. The apparatus of claim 16 also comprising a unit for adjustment of a sample surface being heated relative to the heating source and the temperature recording unit.

19. The apparatus of claim 16 also comprising a unit for recording the level of oscillations of sample surfaces being heated and their parts relative to the heating source and the temperature recording unit during measurements and a unit for correction of sample surfaces temperature measurement results after heating.

20. The apparatus of claim 16 also comprising a unit for recording the power fluctuations of the heating source, a unit for recording locations of the heating spot during heating of samples which correspond to these power fluctuations and a unit for correction of recorded values of heating temperature of samples after the heating in accordance with recorded power fluctuations of the heating source which correspond to recorded heating power fluctuations.
